(19) United States
(12) Patent Application Publication
(10) Pub. No.: US 2016/0260250 A1
(43) Pub. Date: Sep. 8, 2016

(54) METHOD AND SYSTEM FOR 3D CAPTURE BASED ON STRUCTURE FROM MOTION WITH POSE DETECTION TOOL

(71) Applicants: Dejan JOVANOVIC, Austin, TX (US); Keith Beardmore, Santa Fe, NM (US); Kari Myllykoski, Austin, TX (US); James H. Grotelueschen, Glen Ellyn, WA (US); Mark O. Freeman, Snohomish, WA (US)

(72) Inventors: Dejan JOVANOVIC, Austin, TX (US); Keith Beardmore, Santa Fe, NM (US); Kari Myllykoski, Austin, TX (US); James H. Grotelueschen, Glen Ellyn, WA (US); Mark O. Freeman, Snohomish, WA (US)

(21) Appl. No.: 14/639,912

(22) Filed: Mar. 5, 2015

(51) Int. Cl. G06T 17/20; G06T 7/20; G06T 7/00; H04N 13/02

(52) U.S. Cl. CPC G06T 17/20; H04N 13/0203; G06T 7/20; G06T 7/0042; G06T 2207/30244

(57) ABSTRACT

Method and System for 3D capture based on SFM with simplified pose detection is disclosed. This invention provides a straightforward method to directly track the camera's motion (pose detection) thereby removing a substantial portion of the computing load needed to build the 3D model from a sequence of images.

### RELATED APPLICATION

This application is a utility application claiming priority of U.S. provisional application(s) Ser. No. 61/732,636 filed on 3 Dec. 2012; Ser. No. 61/862,803 filed 6 Aug. 2013; and Ser. No. 61/903,177 filed 12 Nov. 2013 Ser. No. 61/948,401 filed on 5 Mar. 2014; U.S. Utility application Ser. No. 13/861,534 filed on 12 Apr. 2013; and Ser. No. 13/861,685 filed on 12 Apr. 2013; and Ser. No. 14/308,874 filed Jun. 19, 2014 and Ser. No. 14/452,937 filed 6 Aug. 2013; Ser. No. 14/539,924 filed 12 Nov. 2004.

### TECHNICAL FIELD OF THE INVENTION

The present invention generally relates to optical systems, more specifically to electro-optical systems that are used to determine the camera orientation and position (collectively known as pose) and capture 3D models relative to the photographed scene in order to extract correct dimensions and positions of physical objects from photographic images.

### BACKGROUND OF THE INVENTION

The task of capturing the 3D information in a scene consists of first acquiring a set of range measurements from the measurement device(s) to each point in the scene, then converting these device-centric range measurements into a set of point locations on a single common coordinate system often referred to as “world coordinates”. Methods to acquire the range measurements may rely heavily on hardware such as 2D time-of-flight laser rangefinder systems which directly measure the ranges to an array of points within the measurement field-of-view. Other systems exist that rely heavily on computing power to determine ranges from a sequence of images as a camera is moved around the object or scene of interest. These later systems are commonly called Structure From Motion systems or SFM. Hardware-intensive solutions have the disadvantages of being bulky and expensive. SFM systems have the disadvantage of requiring extensive computing resources or extended processing times in order to create the 3D representation, thus making them unsuitable for small mobile consumer devices such as smart phones.

Existing Structure from Motion (SFM) systems involve two computation paths, one to track the pose (orientation and position) of the camera as it captures a sequence of 2D images, the other to create a 3D map of the object or environment the camera is moving in or around. These two paths are interdependent in that it is difficult to track the motion (pose) of the camera without some knowledge of the 3D environment through which it is moving, and it is difficult to create a map of the environment from a series of moving camera images without some knowledge of the motion (pose) of the camera.

This invention introduces a method and system for capturing 3D objects and environments that is based on the SFM methodology, but with the addition of a simplified method to track the pose of the camera. This greatly reduces the computational burden and provides a 3D acquisition solution that is compatible with low-computing-power mobile devices. This invention provides a straightforward method to directly track the camera's motion (pose detection) thereby removing a substantial portion of the computing load needed to build the 3D model from a sequence of images.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates an embodiment of the 3D capture system in the process of capturing a sequence of images used to create the 3D model of an object;

FIG. 2 illustrates embodiment illustrated in FIG. 1 but in this case, rather than an object, capturing a scene or portions of a scene for measurement purposes;

FIG. 3 illustrates a block diagram of major architecture components of an embodiment of the system with a laser rangefinder and an inertial measurement unit;

FIG. 4 illustrates the processing flow of the 3D mapping system of the embodiment illustrated in FIG. 3;

FIG. 5 illustrates a block diagram of major architecture components of another embodiment of the system with a laser rangefinder; and

FIG. 6 illustrates the processing flow of the 3D mapping system of the embodiment illustrated in FIG. 5.

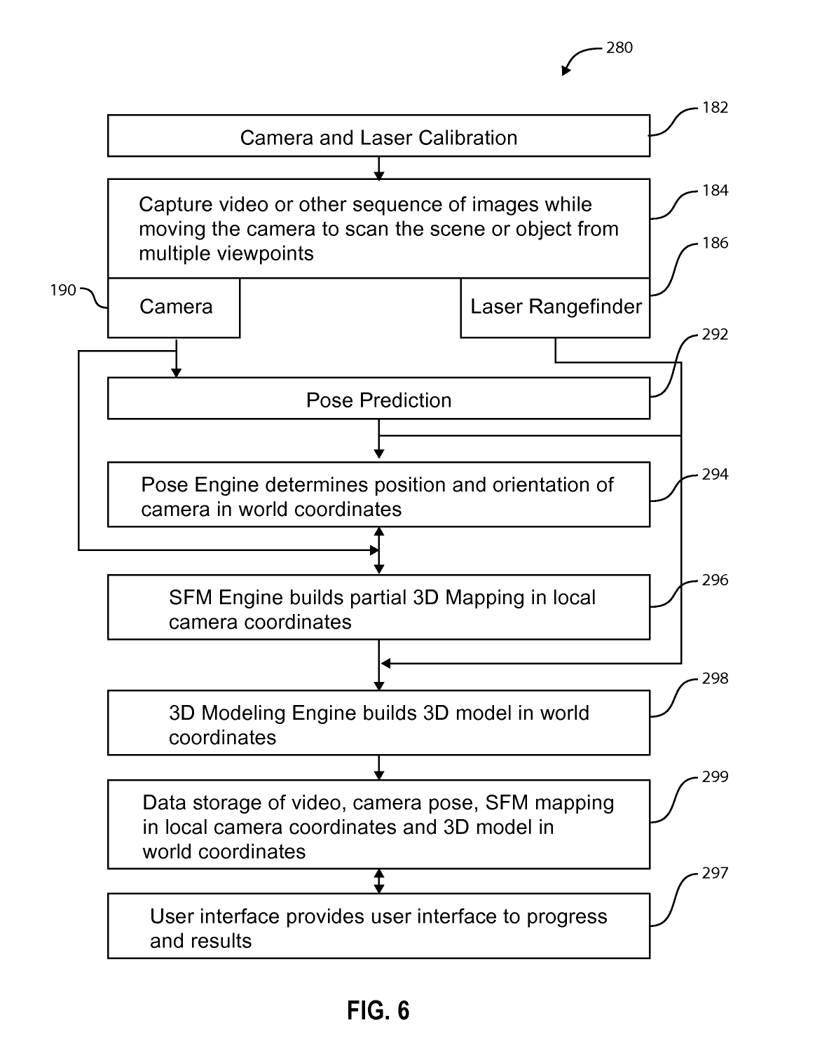

### DETAILED DESCRIPTION OF THE INVENTION

Preferred embodiments of the present invention are illustrated in the FIGUREs, like numerals being used to refer to like and corresponding parts of the various drawings.

Before proceeding with the description it would be helpful to define a few terms for the purpose of this written specification. Some of these terms are used loosely from time to time and may mean different things. For example in the term “pose” of the camera is sometimes used to refer to the “orientation” of the camera independent of the “position” of the camera. In other cases “pose” is used to include both the orientation and the position of the camera. Sometimes the context makes it clear, sometimes it does not. In this specification the distinction of the two meanings is important so we provide clarifying definitions.

Glossary

3D Mapping or 3D Modeling

means a 3D model of an object or scene in world coordinates from which accurate measurements may be derived.

Orientation means the direction in which the central optical axis of the camera is pointed.

Pose means the orientation and position of the camera.

Position means the location of the camera relative to the fixed origin of the world coordinates used in the system.

Proportional 3D Model means a relational data set of the spatial relationship of key features of an object or scene where the scale or absolute size of the model is arbitrary and unspecified.

Range means distance from the point of observation to the point being observed.

SFM means Structure From Motion as further described below.

World Coordinates is a fixed coordinate system for the 3D Mapping which has an absolute position, orientation and scale relative to the scene or object being captured and from which physical measurements of constituent parts of the 3D scene can be extracted.

Structure From Motion (SFM) is a well known technique or category of techniques for determining the 3D mapping of a scene from a sequence of 2D images. Each point of the object or environment being mapped is captured in a minimum of two 2D images. SFM uses the principle of triangulation to determine the range to any point based on how the position of the point shifts in the 2D image from one camera position to another. It is necessary to accurately know the pose (position and angle) of the camera for each of the 2D images in order to be able to correctly calculate the range. Given a sufficient number of 2D views of the scene, existing SFM techniques can determine the pose of the camera in order to create a structural map of the object or scene. However, reliance on the image content alone for determining both the pose of the camera and then a structural model and or structural map is computationally intensive.

Existing SFM methods, whether feature-based or optical-flow-based, must determine corresponding pixels between each video frame in order to track the camera motion. For example, Klein and Murray (“KM”) (identified below) start by creating an initial 3D map based roughly on a stereo pair of images and then estimate the camera's pose relative to this map. For each new frame of video, KM first extrapolates from the camera's prior motion to estimate the camera's new pose. Based on that assumed pose, KM calculates where key scene features should have moved to in the new image, followed by detecting these features in the new image and adjusting the pose to match the image. KM runs the tracking and mapping operations in parallel extensively and intensively using a Graphical Processing Unit (“GPU”) and a Central Processing Unit (“CPU”).

The present 3D Mapping System uses an SFM engine but relieves the SFM engine from having to use this iterative technique for determining the pose of the camera for each image, thereby removing a substantial portion of the computing load needed to build the 3D model from a sequence of images and allowing for the potential for much more accurate results.

The improved mapping system can also be used to produce a non-contact measurement tool and profiler, a robotic vision module, an artificial vision system, and products to help the visually impaired. The products could be integrated as Apps and/or accessories with existing mobile devices such as smart phones, tablets, or notebook computers, or as a stand-alone product. In another embodiment, the digital camera could remain stationary while the scene being recorded is moved to expose views from multiple viewpoints.

The first embodiment of the 3D model capture device employs a smart phone with an auxiliary tool, an accessory to be attached to and used with the smart phone camera or integrated into a smart phone. The accessory contains a laser rangefinder and also uses the smart phone's inertial measurement unit (IMU) consisting of an accelerometer, gyroscope, and compass. In various versions, the IMU may be included in the accessory or it may be built into the smart phone. The laser rangefinder beam is aligned along or near the axis of the camera in a fixed and known position so that range measurements can be directly and accurately associated with the range from the camera to the rangefinder spot in the scene. The laser rangefinder provides an accurate range measurement with each image. Any laser distance measuring technology could be used including triangulation, phase-shift, time-of-flight, and interferometric. The essential characteristic of the distance measuring tool used in this embodiment is that the measurement locations must be visible in the images captured by the camera. In this way, the system knows precise location in the image to which the range measurement applies. Therefore, other distance measurement technologies, such as those based on LEDs or other light sources could also be used. The IMU is used to provide the pointing information of the camera as it is moved. Any type of inertial measurement system, containing at least a 3-axis gyroscope, could be used. The inertial motion and the distance measurements are combined in the Pose Engine to provide an accurate pose estimate.

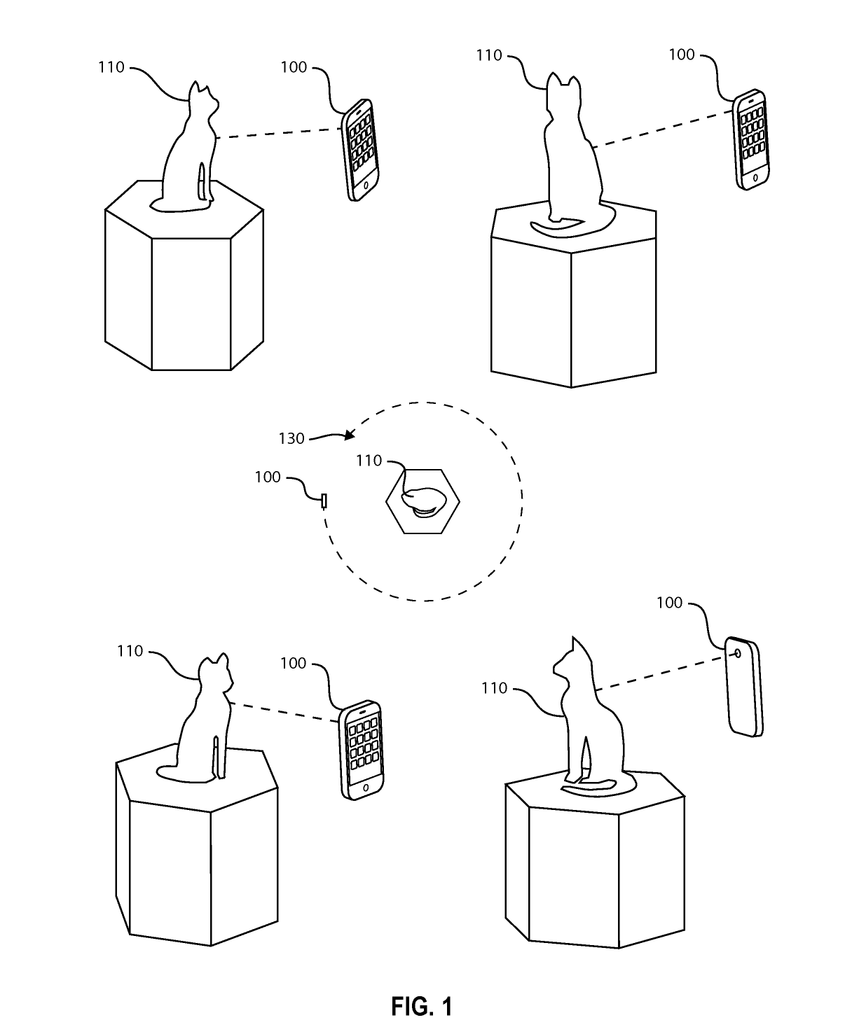

Turning now to FIG. 1, the embodiment of the Mapping System is incorporated in a mobile device 100 which includes a digital camera (not shown)—A standard digital video camera or digital still camera which may be integrated into a smart phone, tablet computer or may be a stand-alone accessory or image capture device. The embodiment illustrated in FIG. 1 also illustrates the use of a laser range finder 112 emitting a laser beam 114. In the embodiment shown, the 3D model to be captured is of an object 110 on a pedestal.

The object to be mapped in the embodiment illustrated in FIG. 1 is the cat statue 110. FIG. 1 illustrates four different camera pose images in the four outer corners of the illustration and a central top view showing a possible motion path 130 of the model capture system 100 in a path 130 around the object 110 to be modeled. Although the image illustrates a circular path of motion 130, it is not necessary that the motion path of the camera be regular. In fact it can be irregular and the irregularity may give better results. This applies to all elements of the change in pose of the camera, both positional change relative to the object and also to the change in orientation of the camera.

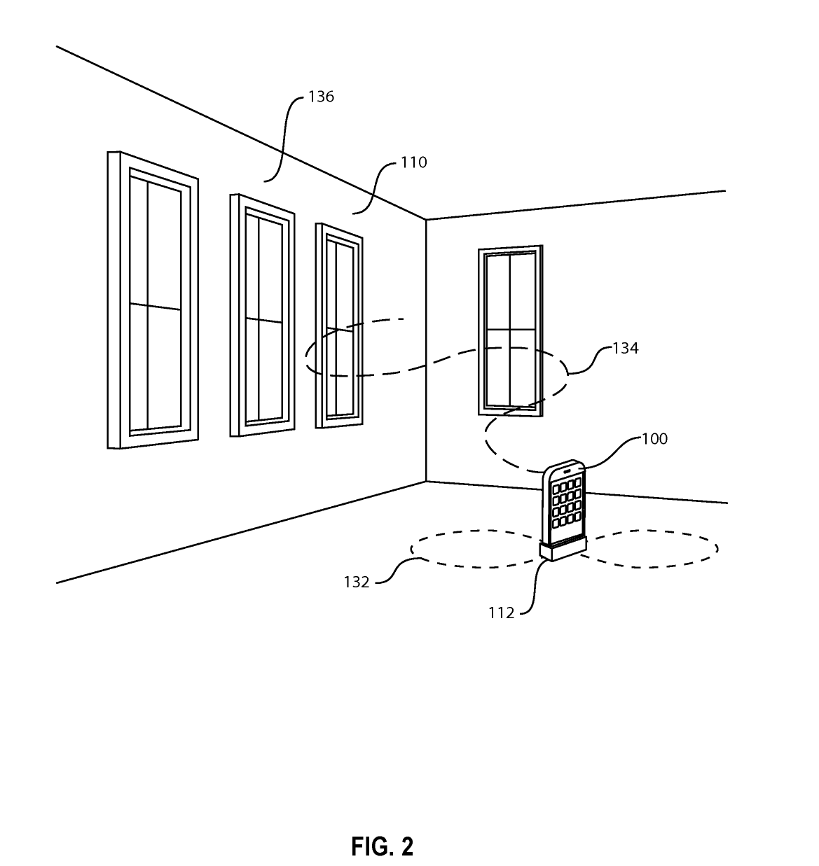

FIG. 2 illustrates the embodiment 100 of the 3D model capture system of FIG. 1 with a laser range finder 112 but the model to be captured is of a scene 111 or portions of the scene for measurement purposes. FIG. 2 illustrates a possible partial movement 132 of the camera (the figure-8 path) and the resultant path of the laser range finder 134 on surfaces 136 in the scene 111. The key concept illustrated is that the camera device is moved on a path such that the camera covers a range of positions as the image sequence is captured as opposed to remaining approximately stationary with just its orientation changed to capture images of the complete scene. Since SFM is based on triangulation, greater measurement accuracy is achieved by having a larger triangulation baseline. In the case illustrated in FIG. 2, this means that the 3D model accuracy of each point of interest in the scene is increased as the range of camera positions capturing the image of the points of interest is increased. Therefore, the camera path while capturing the sequence of 2D images from which the 3D model or measurements are calculated should have both positional and orientation changes in viewpoint, with a greater range of positions producing a more accurate 3D model or measurement.

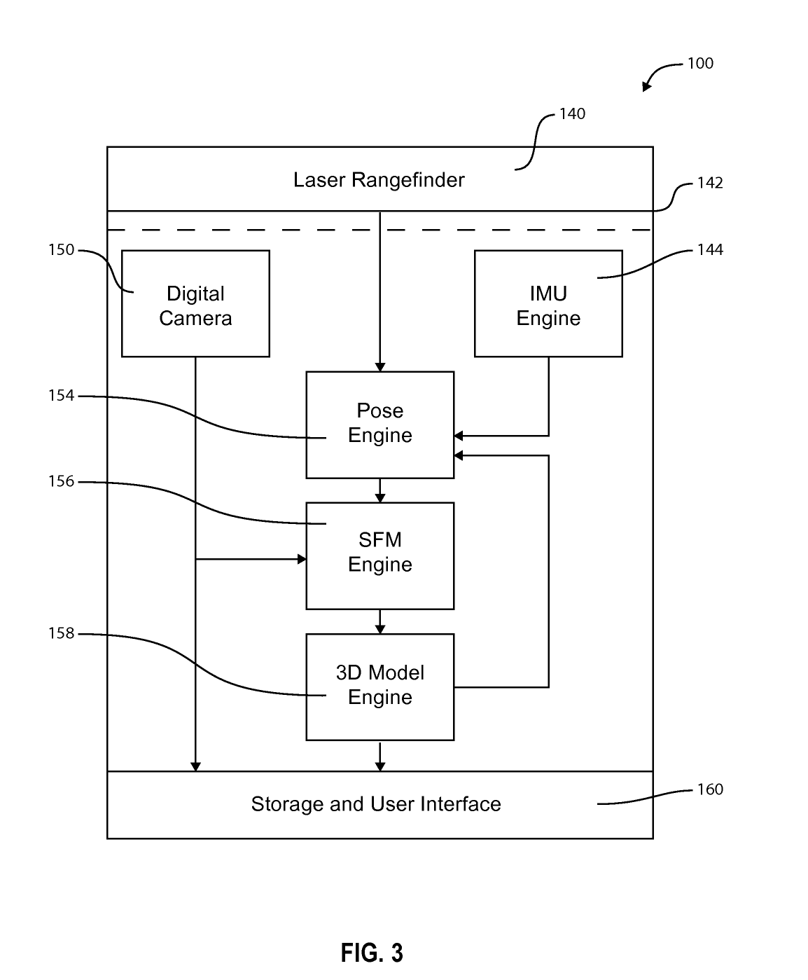

FIG. 3 illustrates a block diagram of major architecture components of an embodiment of the system and the relationship between the components and processing elements used in the embodiment illustrated in FIG. 1. The embodiment 100 includes a digital camera 150 capable of capturing video or some other sequence of images. The embodiment also includes a laser range finder 140 and an inertial measurement unit (IMU) engine 144. In the embodiment shown the laser range finder is in an accessory attachment 142. The device also includes a pose engine 154 which calculates the orientation and position of the camera. In the embodiment shown in FIG. 3 as further described below, the pose engine generates the orientation portion of the pose using input from the IMU and uses the laser range finder for the position portion of the camera pose determination for each image relative to the point in the scene illuminated by the laser spot. The position vector in world coordinates is derived by adding to the laser rangefinder position vector an offset vector that connects the laser illuminated point to the world coordinate origin as described in more detail below.

The embodiment illustrated in FIG. 3 also includes an SFM engine 156. In this embodiment the SFM engine uses image data captured by the camera 150 together with pose data from the pose engine 154. Thus the computational complexity of using an SFM engine to calculate camera pose has been avoided. A preferred embodiment for the SFM engine is based on optical flow. The SFM engine 156 operates on pairs of 2D images taken by the camera from different poses. Typically the SFM engine 156 operations are performed on pairs of adjacent images (adjacent in a capture sequence) although non-adjacent images could also be used. For each pair of images, the motion of points in the scene is estimated using an automatic optical flow calculation. Then, using the camera pose determined by the Pose Engine, the range to points in the scene is calculated from the optical flow field. Alternatively, there are a number of other SFM techniques for generating a 3D mapping. For example See:
Klein, G., & Murray, D. of Oxford, UK: Active Vision Laboratory, University of Oxford, “Parallel Tracking and Mapping for Small AR Workspaces”, published in International Symposium on Mixed and Augmented Reality (2007);
Newcombe, R. A., et. al. of London, UK: Department of Computing, Imperial College, “DTAM: Dense Tracking and Mapping in Real Time”, published in International Conference on Computer Vision, (2011);
Zucchelli, M., of Stockholm: Royal Institute of Technology, Computational Vision and Active Perception Laboratory, “Optical Flow based Structure from Motion”, Doctoral Dissertation (2002) Note: Zucchelli, M. describes the use of optical flow in SFM using a more computationally intensive indirect method to estimate the camera's pose compared to the direct camera pose measurement used here; and
Petri Tanskanen, et. al., of Zurich, Swiss Federal Institute of Technology (ETH), “Live Metric 3D Reconstruction on Mobile Phones”, published in International Conference on Computer Vision, (2013).

Optical Flow is a technique used to track the movement of points or features in a scene from one image of the scene to another. Mathematically, this can be described as follows. Given a point [u_{X}, u_{y}] in image I₁, find the point [u_{X}+δₓ, u_{y}+δ_{y}] in image I₂ that minimizes the error ε in a neighborhood around the point, i.e., minimize

$$ɛ ( {δ}_{x} , {δ}_{y} ) = {\sum }_{x = {u}_{x} - {w}_{x}}^{{u}_{x} + {w}_{x}} {\sum }_{y = {u}_{y} - {w}_{y}}^{{u}_{y} + {w}_{y}} ( {I}_{1} ( x , y ) - {I}_{2} ( x + {δ}_{x} , y + {δ}_{y} ) ) .$$

This technique was originally developed by Horn and Schunck as described in the following reference.
See Berthold K. P. Horn and Brian G. Schunck, “Determining optical Flow: a retrospective”, Artificial Intelligence, 17:185-203, 1981.

In the present invention, optical flow is one choice of techniques used to determine the motion of features in the scene from one image to the next in the series of images. The result of this optical flow computation is combined with the camera pose information obtained from the pose engine to calculate the distance to points in the scene based on SFM triangulation.

In the present embodiment discussed, a 3D modeling engine 158 converts the 3D mapping output from the SFM engine 156 in local camera coordinates into a 3D model in world coordinates. The 3D Modeling engine takes the 3D map points generated by the SFM engine in local camera coordinates and assembles the data from the complete sequence of 2D images into a single 3D model of the scene in world coordinates. It uses the ranges from the SFM Engine along with the known camera pose for each local range data set to map the points into the fixed world coordinates. This is done with a coordinate transformation whose transformation matrix values are determined from the pose and that maps the points from the local camera coordinates into world coordinates. The 3D Modeling Engine also may include data processing routines for rejecting outliers and filtering the data to find the model that best fits the collection of data points.

Finally the Modeling device contains a User Interface and Data Storage functions—that provides the user with choices as to how the 3D model and data is to be displayed and stored. The user can request a printer-ready 3D file, dimensional measurements extracted from the model, as well as other operations specific to the application. The 3D model is stored together with application specific data in a Quantified Image/Data File.

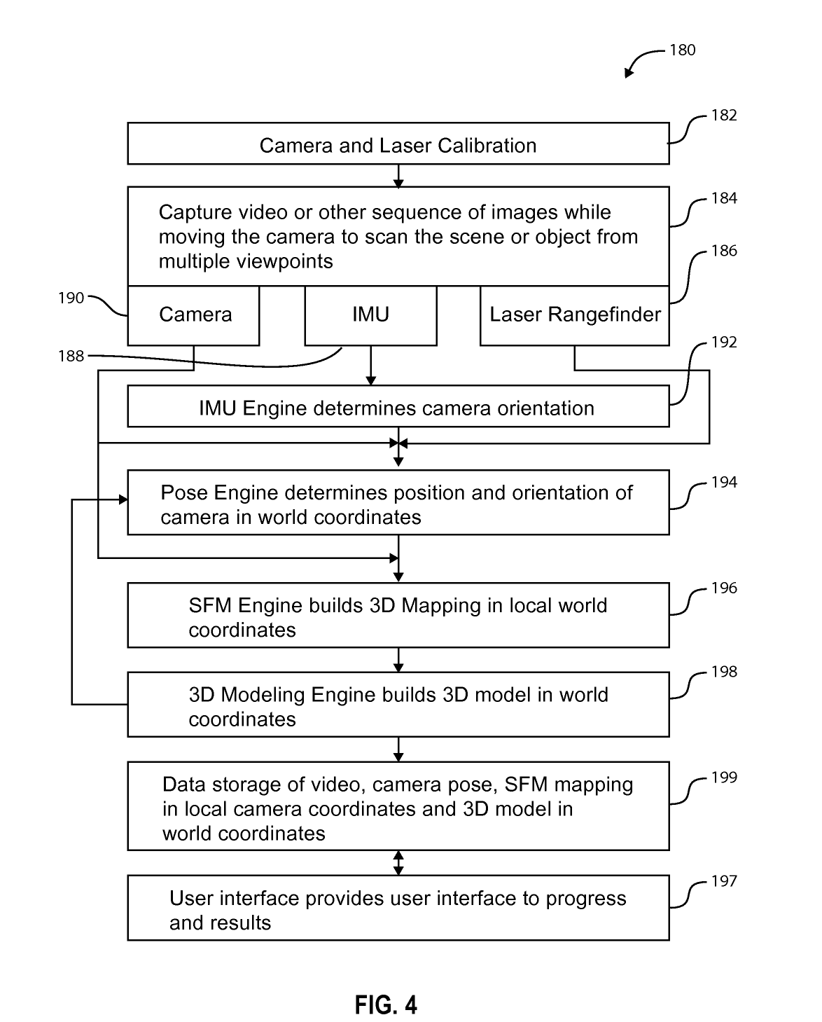

FIG. 4 illustrates the operational flow 180 of using the 3D Capture and Modeling System embodiment illustrated in FIG. 1, FIG. 2 and FIG. 3. The first step 102 is the model calibration routine 182 for the laser range finder and the camera where the fixed spatial relationship between the laser beam and the camera is learned and fixed. This is more important for embodiments where the laser range finder is housed in an accessory device that attaches to the camera. In the next step 184, image data is captured with the camera for a sequence of images 190, while pose data is collected from the IMU 188 and the laser range finder 186. For each image captured by the camera, the related IMU data is fed into the IMU engine which determines the camera's orientation 192 for each image.

Inertial measurement units (IMU), which consist of gyroscopes, accelerometers, and optional compass are a multi-sensor unit that can provide rotational measurements along with instantaneous acceleration about multiple axes determined by the configuration of the unit. It is well known that position estimation based on the IMU is plagued with drift and inaccuracy. This is due to the fact that position is estimated by twice integrating the acceleration data. i.e.,

$$a = \frac{{d}^{2} x}{d t}$$

$$v = \frac{d x}{d t} = \int a d t$$

$$x = \int v d t$$

where x is position, v is velocity, and a is acceleration. Any noise at all in the acceleration data as well as any inaccuracy in estimating the gravity vector results in huge errors in the position estimate. (Note: The gravity vector must be accurately subtracted from the accelerometer signals so that just the motion acceleration data remains. This is complicated by the fact that the direction of gravity relative to the IMU device changes with the orientation of the IMU.) For this reason, estimating the camera position based on tracking the motion using the IMU data is inherently inaccurate. (Note: The technique described in [Tanskanen (2013)] uses an IMU alone to estimate the camera pose. This accounts for the significant difference between the ground truth pose and the estimated pose even after substantial iterative processing. The present embodiment avoids this error source by using a laser rangefinder in conjunction with the IMU.)

On the other hand, the IMU, with proper processing of the sensor data, can provide a very accurate and stable measurement of orientation (or pointing direction).

The laser rangefinder is designed to provide accurate distance measurements but provides no information about the direction of the laser beam. For example, a commercial laser measurement tool made by Bosch (model DLR130K) claims an accuracy of 1.5 mm at distances up to 40 m.

The IMU-engine-generated orientation data feeds into the pose engine together with information from the laser rangefinder to determine the pose of the camera including both the orientation and the position of the camera relative to the point illuminated by the laser for each image 194. In some embodiments the camera image data is employed by the pose engine to determine the range. Using the IMU data and range data, the pose engine is capable of setting the pose in world coordinates 194. The position portion of the pose in world coordinates is determined by adding to the laser rangefinder vector, an offset vector that connects the laser-illuminated point to the world coordinate origin or to another reference point in the scene whose spatial relationship to the world coordinate origin is known. Two axes of this offset vector are taken directly from the position of the world coordinate origin or reference point in each image relative to the laser illuminated point. The third axis is determined in the 3D modeling engine as the model is assembled from the multiple viewpoints by solving for the value that gives a resulting model with the best consistency from all viewpoints.

The laser range finder may emit its laser beam coincident with the axis of the camera, parallel to the axis of the camera with a known offset, or at a known offset and angle with the axis of the camera. The IMU, which is also affixed to the camera/laser rangefinder assembly, provides the orientation of the camera. The laser rangefinder provides the distance of the camera from a point in the scene that is illuminated by the laser spot. This directly gives the camera pose relative to the illuminated spot. This position vector of the laser-illuminated point is added to the offset vector as described previously to give the camera position in world coordinates. The 3D model of the scene is then assembled frame-by-frame using the triangulated SFM values, adjusting the third coordinate of the offset vector with a constraint that the points illuminated by the laser in each image map to points in the 3D model consistent with the camera pose.

Once information for at least two images has been gathered and determined by the pose engine, the camera image data and pose determination are shared with the SFM engine which builds a 3D mapping in local camera coordinates 196. And then the 3D modeling engine creates the model in world coordinates 198. As the process proceeds, the information captured and generated is stored and the user interface provides the user with access to the information and allows the user to initiate queries concerning real world measurements related to the object or scene 199.

The camera is employed to take a video or other sequence of images of the scene or object from a variety of camera poses (position(s) and orientations). In other words, the camera is moved around scanning the scene or object from many viewpoints. The objective of the movement is to capture all of the scene or object. It should be noted that the efficiency of creating the 3D model and accuracy of 3D model are dependent on the image sequence. Less data may result in greater efficiency but less accuracy. More data may be less efficient but provide more accuracy. After a certain amount of data, more data will result in diminishing returns in increased accuracy. Depending on the scene or object to be modeled, different movement paths will result in greater efficiency and accuracy. Generally, a greater number of camera images (video frames) from a wide range of camera poses, in particular a wide range of camera positions, should be used on areas of the object or scene where accuracy is of the greatest interest.

The origin of the world coordinate system is a specific point from which a range has been determined by the range finder in combination with the pose engine. Further range findings are always referenced to the single world coordinate origin.

The SFM engine automatically detects points of interest in the images of the object or scene and estimates the motion of the points of interest from one image to the next using optical flow or other known SFM techniques, thus building a structural mapping of the object or scene. For this reason, it has been found preferable to begin the camera scanning process in a manner that targets one of these expected points of interest with the laser rangefinder. The modeling engine then takes the structural model estimates from the SFM engine output and the pose (camera position and orientation) output of the pose engine to begin creating a 3D model of the object or scene in world coordinates. The 3D modeling engine weights the information and makes determinations as to the best fit of the available data. The 3D modeling engine also monitors the progression of changes to the model as new information is evaluated. Based on this progression, the 3D modeling engine can estimate that certain accuracy thresholds have been met and that continued processing or gathering of data would have diminishing returns. It may then, depending on the application, notify the user that the user selected accuracy threshold has been achieved. The resultant 3D model is saved and the user is provided with a display of the results and provided with a user interface that allows the user to request and receive specific measurement data regarding the modeled object or scene.

The second embodiment of the auxiliary tool is also an accessory to be attached to and used with the camera, or may be integrated into the camera device. In this embodiment, the accessory also contains a laser rangefinder device. The laser rangefinder beam is aligned along or near the axis of the camera in a fixed and known position so that range measurements can be directly and accurately associated with the range from the camera to the rangefinder spot in the scene. The same considerations for the distance measurement technology that were stated previously for the first embodiment also apply to this embodiment. Again, the essential characteristic of the distance measuring tool used in this embodiment is that the measurement locations must be visible in the images captured by the camera. In this way, the system knows the precise location in the image to which the range measurement applies. In this embodiment, it is not necessary that a range measurement be made for each image in the image sequence. It is sufficient that as few as one range measurement is made for the complete sequence of images.

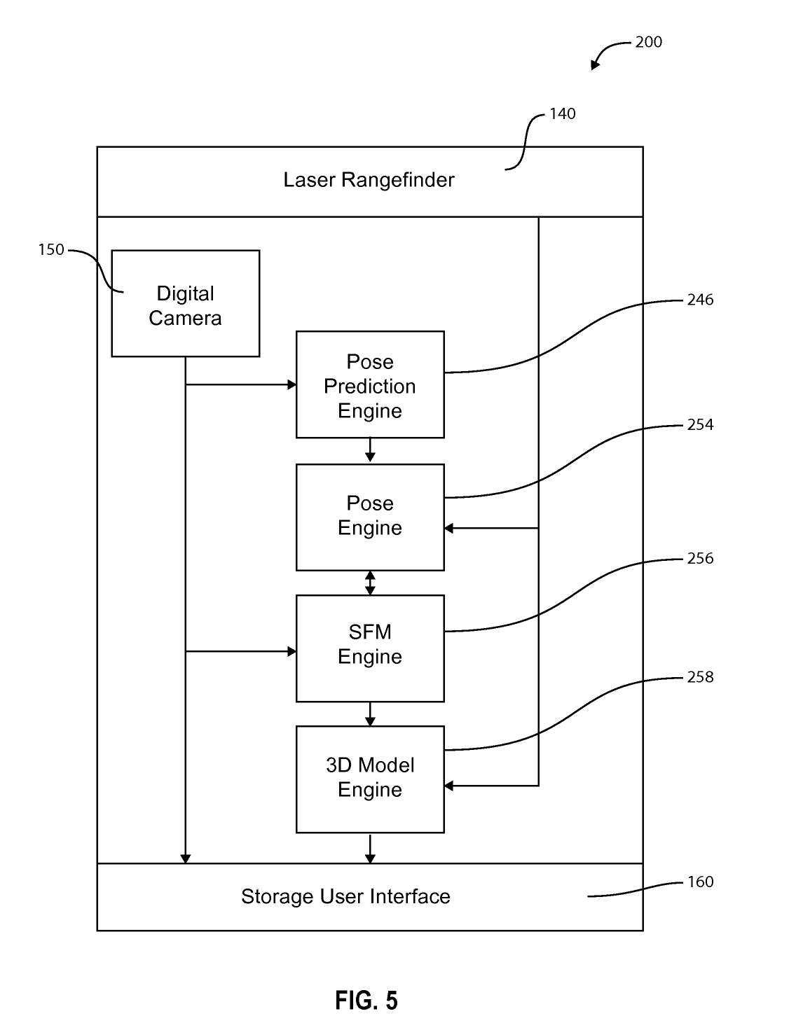

FIG. 5 illustrates a block diagram of major architectural components of this second embodiment 200. This embodiment employs the digital camera 150 and a laser range finder 140. However, unlike the first embodiment, it does not use an IMU, rather it uses a pose prediction engine. This engine guesses at the orientation and position of the camera relative to the image based on extrapolating the pose movement from previous images in the sequence and by looking at changes in proportion of relative points of interest in the images 246. Without ranging information from the laser rangefinder, the system would then be able to exchange information with the SFM engine and 3D modeling engine to iteratively refine the SFM map and camera pose as described in the SFM references cited earlier in this specification, for example as described in KM. This results in a proportional 3D model or mapping of the object or scene scanned 256. Using information from the laser rangefinder to adjust the scale of the proportional 3D model, the 3D modeling engine generates a 3D model of the object or scene from which real world measurements can be extracted 160.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations could be made hereto without departing from the spirit and scope of the disclosure.

1. A 3D modeling capture device comprising
a camera which captures a sequence of images from a sequence of poses relative to the scene or objects being mapped
an IMU (inertial measurement unit) engine fixed to the camera which tracks the orientation of the camera about multiple axes
a laser rangefinder fixed to the camera which determines the distance from the camera to a point in each image in the sequence of images
a pose engine which determines the orientation and position of the camera from the output of the IMU and the laser rangefinder;
a SFM (Structure from Motion) engine which tracks the relative movement of features in a scene from one image to another image and generates a structural model of the scene;
a mapping engine which combines product from the pose engine with product from the SFM engine to provide dimensionally correct 3D map output of the scene.

2. The 3D modeling capture device of claim 1 where the laser rangefinder is a phase-shift laser rangefinder

3. The 3D modeling device of claim 1 where the sequence of poses is fully or partially achieved by moving the object(s) to be modeled.

4. The 3D modeling device of claim 1 where SFM engine tracks motion of features in the scene from one image to the next using optical flow.

5. The 3D modeling device of claim 1 where the 3D modeling engine detects and rejects outlier data to find a model that best fits the collection of data.

6. The 3D modeling device of claim 5 where the 3D modeling engine uses data filtering to reject outlier data to find a model that best fits the collection of data.

7. The 3D modeling device of claim 1 where the user can query the modeling device to receive specific dimensional measurements from the 3D model.

8. The 3D modeling device of claim 1 where the dimensionally correct 3D modeling of the scene/object is monitored to estimate the accuracy of the model as more data is captured.

9. The 3D modeling device of claim 8 where the user is notified that the estimate accuracy threshold of the 3D model has been reached.

10. The 3D modeling capture device of claim 1 which stores the captured information in a Quantified Data File containing a combination of some or all of the following: video image sequence, camera pose, SFM mapping, 3D Model, automatically selected or user selected measurements, application specific data.

11. A 3D mapping device comprising
a camera which captures a sequence of images from a sequence of poses relative to the scene or objects being mapped
a laser rangefinder to determine the distance from at least one feature in the scene
a pose prediction engine which predicts the pose change of the camera between two scenes
a pose engine which refines the estimated orientation and position of the camera from the output of the pose prediction engine and information exchange with the SFM engine
a SFM (Structure From Motion) engine which tracks the relative movement of features in a scene from one image to another image and generates a proportional 3D model of the scene using information from the pose engine;
a 3D mapping engine which combines product from the pose engine with product from the SFM engine and the laser rangefinder to provide dimensionally correct 3D map output of the scene.

12. The 3D modeling capture device of claim 11 where the laser rangefinder is a phase-shift laser rangefinder

13. The 3D modeling device of claim 11 where the sequence of poses is fully or partially achieved by moving the object(s) to be modeled.

14. The 3D modeling device of claim 11 where SFM engine tracks motion of features in the scene from one image to the next using optical flow.

15. The 3D modeling device of claim 11 where the 3D modeling engine detects and rejects outlier data to find a model that best fits the collection of data.

16. The 3D modeling device of claim 15 where the 3D modeling engine uses data filtering to reject outlier data to find a model that best fits the collection of data.

17. The 3D modeling device of claim 11 where the user can query the modeling device to receive specific dimensional measurements from the 3D model.

18. The 3D modeling device of claim 11 where the dimensionally correct 3D model modeling of the scene/object is monitored to estimate the accuracy of the model as more data is captured.

19. The 3D modeling device of claim 18 where the user is notified that the estimate accuracy threshold of the 3D model has been reached.

20. The 3D modeling capture device of claim 11 which stores the captured information in a Quantified Data File containing a combination of some or all of the following: video image sequence, camera pose, SFM mapping, 3D Model, automatically selected or user selected measurements, application specific data.
